(19) United States
(12) Patent Application Publication
(10) Pub. No.: US 2005/0081316 A1
(43) Pub. Date: Apr. 21, 2005

(54) Roller for rotating cylindrical brushes applicable in any industrial, road-related or other sector

(76) Inventors: Andrea Dondi, Casinalbo (IT); Roberto Dondi, Casinalbo (IT)

Correspondence Address: MODIANO & ASSOCIATI, Via Meravigli 16, MILANO, 20123, IT

(21) Appl. No.: 11/003,347

(22) Filed: Dec. 6, 2004

(30) Foreign Application Priority Data
Dec. 13, 2002 (IT) BO2002A000784
Nov. 17, 2003 (EP) 03026175.4

(51) Int. Cl. B25F 5/02; F16C 13/00

(52) U.S. Cl. 15/179; 492/40

(57) ABSTRACT

A roller for rotating cylindrical brushes that can be applied in any industrial, road-related or other sector, of the kind constituted by a central support, on the outer surface of which a plurality of holes for inserting and fixing respective tufts of bristles are distributed with a constant spacing, the support being constituted by at least one cylindrical ring and the holes being arranged on planes that are perpendicular to the axis of the roller and are successively and alternately inclined on either side with respect to planes that are radial or parallel to radial planes that pass through the axis of the cylinder and through the respective hole in order to sweep, with the ends of the bristles, two bands arranged laterally to the row of tufts.

The present invention relates to a roller for rotating cylindrical brushes that can be applied in any industrial, road-related or other sector.

### BACKGROUND OF THE INVENTION

In the particular sector of brushes for industrial, road-related or other uses, large cylindrical brushes are known which have tufts of bristles or filaments, which can be even 30 centimeters long and even more than 4 meters wide and are installed and actuated so that they can rotate about a horizontal axis for cleaning and treating any surface, for example courtyards, streets, squares, industrial buildings or the like.

The arrangement of the tufts of bristles in these kinds of roller does not entail particular problems and ensures a good result in terms of cleaning and/or treatment, without leaving any untreated regions.

Brushes are also known which are constituted by a plurality of rings adapted to be assembled and packed side by side, optionally with spacers interposed, on a central tubular core: such rings have bristles that usually extend at right angles to the rotation axis (radial direction) and are usually arranged on planes that are perpendicular to the axis of the central tubular core.

The radial arrangement of the bristles forms dirt release regions between the contiguous rows of bristles; due to the linear motion of the roller on the surface to be cleaned, said release regions assume the shape of narrow elongated streaks of dirt that are deposited by the roller itself.

Moreover, with the arrangement of the tufts of bristles in a ring or roller, there are no lateral motions that tend to better remove dirt from the surface being cleaned and/or treated.

In conventional brushes it is usually not possible or convenient to arrange bristles made of different materials on the same ring: moreover, the ring requires a certain pressure in order to reach the regions located between two contiguous rings of bristles, and this leads to faster wear and, with wear, to less effective cleaning.

### SUMMARY OF THE INVENTION

The aim of the present invention is to eliminate the above-noted drawbacks of the prior art, by providing a roller for rotating cylindrical brushes that can be applied in any industrial, road-related or other sector and does not leave streaks of dirt on the surfaces on which it acts, removes dirt forcefully also by means of lateral motion components, can be fitted with filaments of different kinds, operates without the need for high pressures and therefore has a reduced wear and reduces the stresses affecting the mechanical parts.

Within this aim, an object of the present invention is to provide a roller for rotating cylindrical brushes that is simple, relatively easy to provide in practice, safe in use and effective in operation.

This aim and this and other objects that will become better apparent hereinafter are achieved by the present roller for rotating cylindrical brushes that can be applied in any industrial, road-related or other sector, of the kind constituted by a central support, on the outer surface of which a plurality of holes for inserting and fixing respective tufts of bristles are distributed with a constant spacing, characterized in that said support is constituted by at least one cylindrical ring and in that said holes are arranged on planes that are perpendicular to the axis of the roller and are successively and alternately inclined on either side with respect to planes that are radial or parallel to radial planes that pass through the axis of the cylinder and through the respective hole in order to sweep, with the ends of the bristles, two bands arranged laterally to the row of tufts.

### BRIEF DESCRIPTION OF THE DRAWINGS

Further characteristics and advantages of the present invention will become better apparent from the following detailed description of a preferred but not exclusive embodiment of a roller for rotating cylindrical brushes that can be applied in any industrial, road-related or other sector, illustrated by way of non-limiting example in the accompanying drawings, wherein:

FIG. 1 is a front view, with tufts shown schematically, of a roller for rotating cylindrical brushes applicable in any industrial, road-related or other sector in a spaced configuration;

FIG. 2 is a front view, with tufts shown schematically, of a roller for rotating cylindrical brushes applicable in any industrial, road-related or other sector with a plurality of rings in a packed configuration;

FIG. 3 is a front view, with tufts shown schematically, of a roller for cylindrical brushes with a single ring with tufts distributed along mutually spaced circles;

FIG. 4 is a front view, with tufts shown schematically, of a roller for cylindrical brushes with a single ring coiled in a cylindrical spiral;

FIG. 5 is a perspective view of a narrow central support with a row of tufts of bristles, in which, for the sake of clarity, a single bristle for each tuft and the imaginary annular band swept by the bristles have been shown;

FIG. 6 is a side view of a support on which sixteen tufts of bristles are distributed, the tufts being numbered progressively with Roman numerals that designate, by means of corresponding black arrows, respective sectional planes;

FIG. 7 is a view of the ordered succession of the cross-sections of the support of FIG. 6;

FIG. 8 is a side view of a supporting portion with holes for the tufts of bristles distributed in a cylindrical spiral that is wound along one spacing pitch;

FIG. 9 is a view of the ordered succession of the cross-sections of the support of FIG. 8.

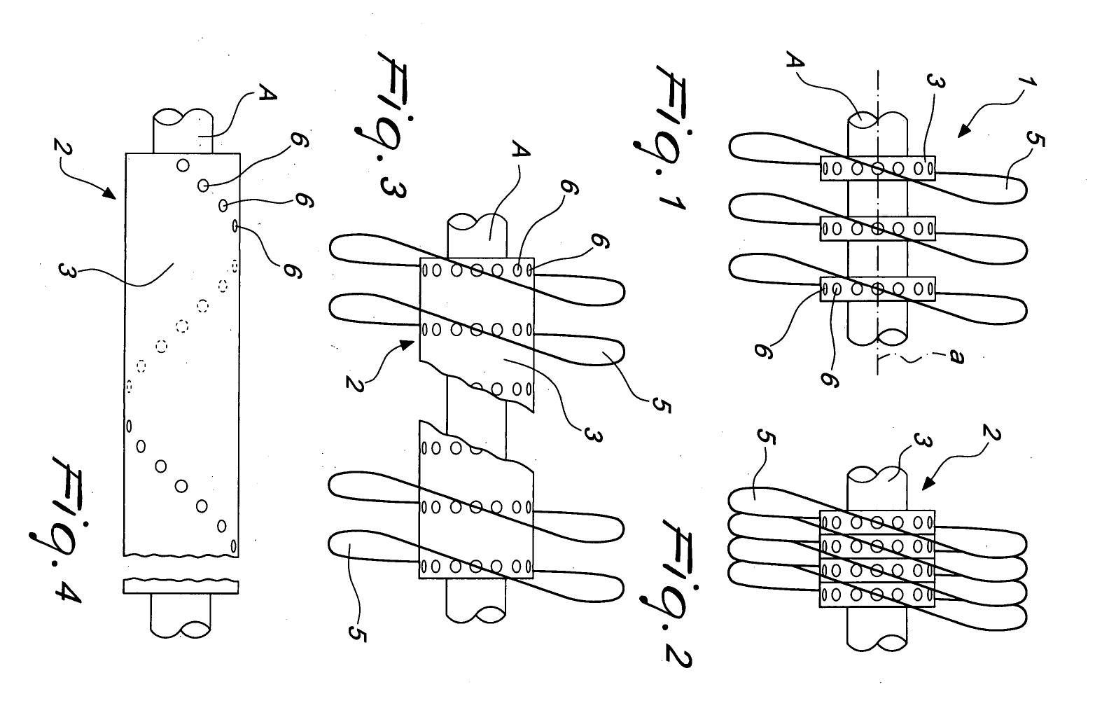

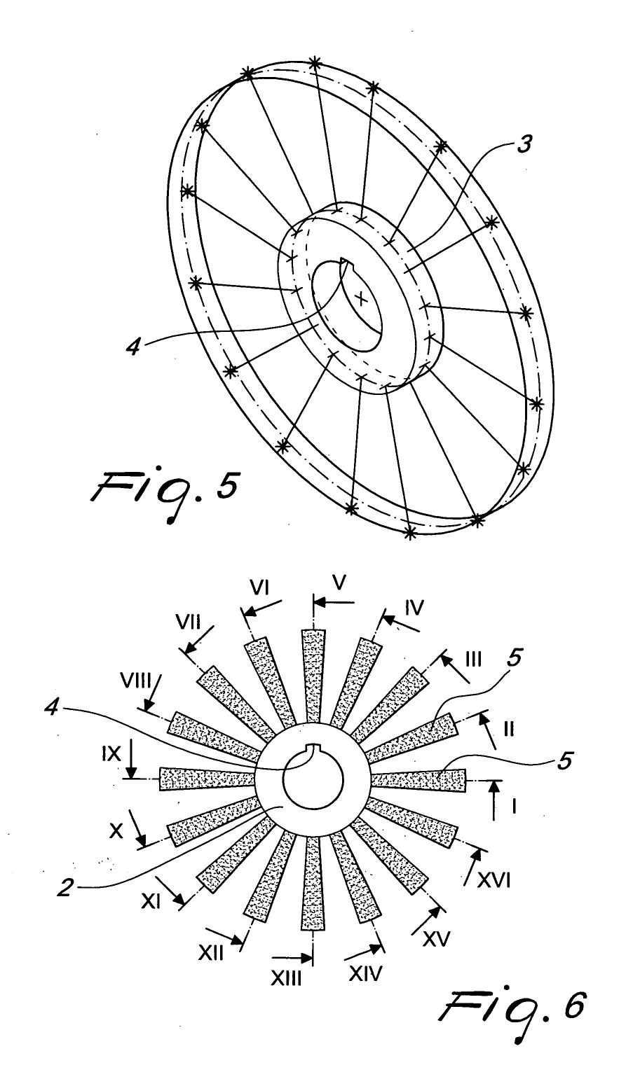

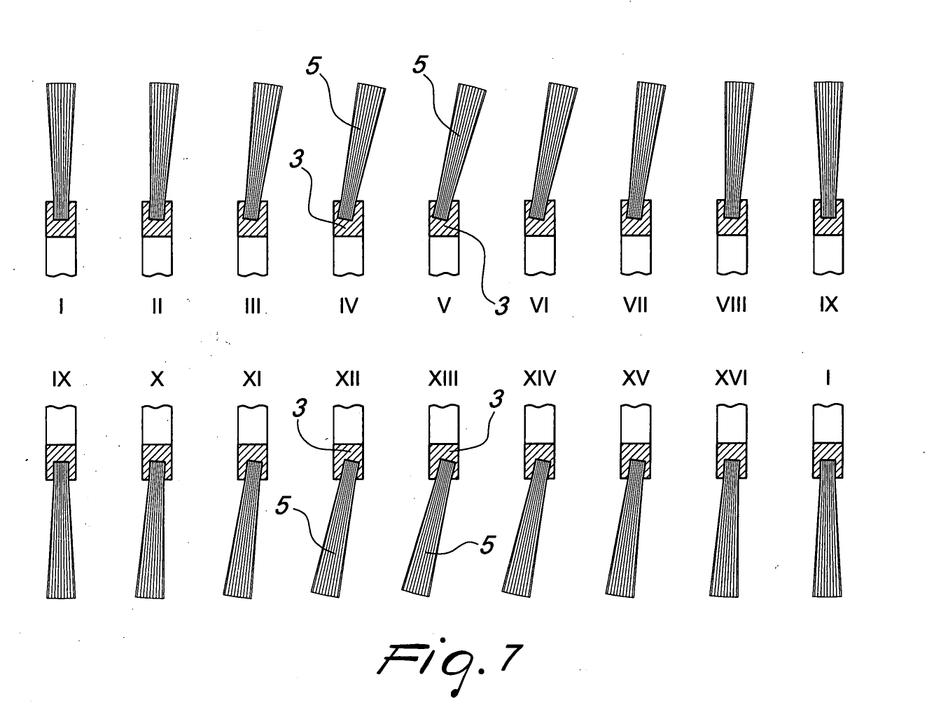

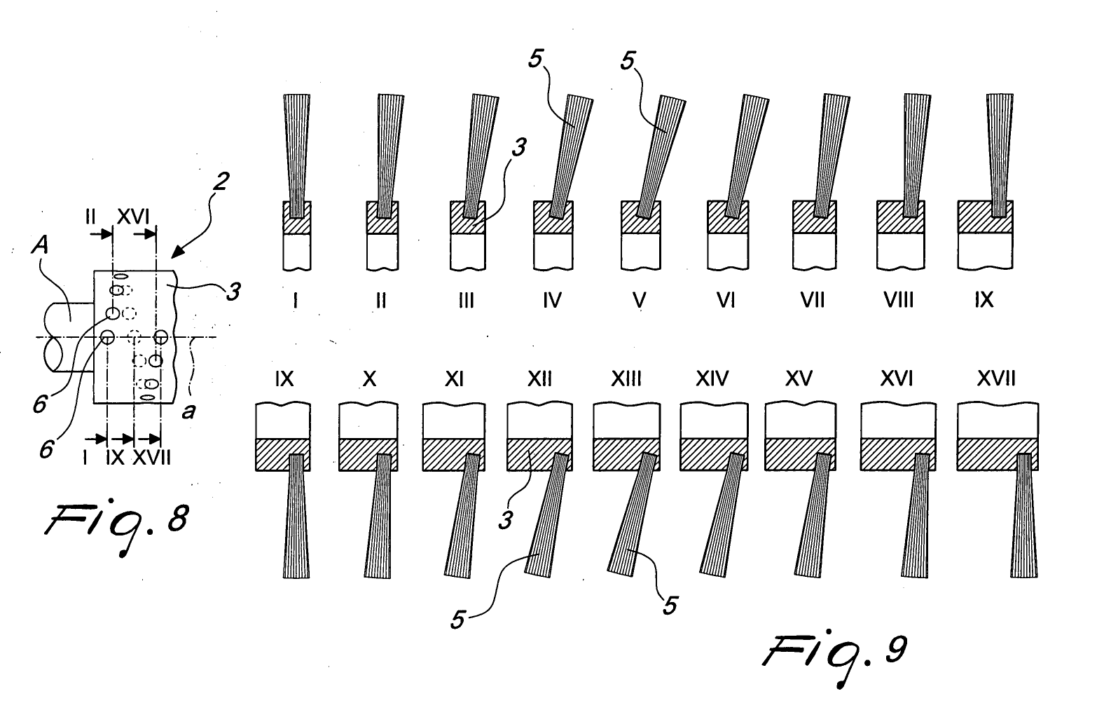

### DESCRIPTION OF THE PREFERRED EMBODIMENTS

With reference to the figures, the reference numeral 1 generally designates a roller for rotating cylindrical brushes that can be applied in any industrial, road-related or other sector according to the invention.

The roller 1 is of the type that comprises a central support 2, which is constituted by at least one cylindrical ring 3 formed by molding or by extruding a material such as plastics, wood, metal alloys, which has a cylindrical tubular shape and a maximum thickness for example of thirty millimeters. The rollers are keyed on a substantially horizontal rotating actuation shaft A, and in relation to this, for example, in a preferred embodiment the central hole of the support has at least one radial slot 4 for rotary coupling to a corresponding external longitudinal rib for coupling of the shaft A.

The presence and size of the slot 4 are closely correlated to the shape and dimensions of the support, and in some cases the slot may not be present: clearly, the mutual staggering of the different rings 3 becomes necessary when a plurality of rings are present, in which case the longitudinal rib also acts as an element for staggering the different rings.

Various kinds of element are used to stagger rollers with a plurality of rings, and therefore the radial slot 4 may have any shape and dimensions, and a different number of rings 3 may be present.

The bases of the support are cut along two parallel planes that are perpendicular to the direction of the axis a of the cylindrical ring.

The reference numeral 5 designates tufts of bristles that are distributed along the ring 3 and lie on planes that are perpendicular to the axis a of the ring; in particular, they can be either actually radial or parallel to a radial plane but slightly offset by a short extent from said plane; with this distribution of the tufts of bristles, actuating the roller in one direction produces a sort of soft brushing of the treated surface, while rotation in the opposite direction has a more forceful scraping effect on the surface.

The tufts 5 have one of their ends inserted and secured by means of a metal staple or glued or heat-sealed in a corresponding hole 6 of the support, which is radial or parallel to a plane that is radial but slightly offset by a short extent from said plane.

The holes 6 are successively and alternately inclined on either side by angles that are comprised between 0 and 35 positive degrees and between 0 and 35 negative degrees with respect to radial planes that pass through the axis of the cylinder and through the respective hole in order to sweep, with the ends of the bristles, two bands located laterally to the row of tufts.

The tufts of bristles are made of synthetic material (such as for example polypropylene and/or nylon and/or polyester), natural material (of animal or plant origin), and/or metallic material, and can be distributed in the holes with different characteristics, alternating tufts of a certain material with tufts of a different material; the tufts may also be made of bristles having several diameters and/or different materials; it is possible to alternate on the shaft A rings provided with bristles and spacer rings 7 that are likewise cylindrical and have no bristles.

The width of the support 2 may be any, even up to the full length of the roller, or can be slightly wider than a row of tufts: in this case, a spacer ring of any width can be interposed between the supports and the holes for the tufts can be distributed on any number of rows and be arranged so that they are aligned or mutually offset: in particular, the holes can be distributed along rings or along a cylindrical spiral having any spacing pitch correlated to the cleaning requirements of the roller: the pitch of the spiral may be any, and as the pitch increases the alternating inclination of the bristles on either side must also increase.

The operation of the invention is as follows: by means of the rotation of the shaft A that moves the support or pack of supports 2, the crest of the free end of the tufts 5 oscillates laterally on either side, affecting a certain width of the surface to be cleaned in front of the roller that is larger than the distance between two contiguous rows of tufts: in practice, with the rotation of the roller through 360 degrees, the ends of the bristles have, with respect to the surface to be cleaned, two mutually perpendicular movements: a longitudinal one, tangentially to the free ends of the bristles, and a transverse one, produced by the inclination of the bristles on either side.

Thanks to the inclination of the tufts of bristles 5, no “dead” regions are left on the surface to be treated: moreover, the inclined distribution of the bristles produces a lateral motion component that tends to improve the final results in terms of cleaning and treatment of surfaces.

Moreover, it is possible to alternate tufts of bristles made of different materials without producing uneven cleaning bands.

It is also noted that the bristles are slightly longer than the bristles inserted in the support radially in a conventional manner; in this manner, the wear of the bristles is reduced and accordingly the roller has a longer life.

It has thus been shown that the invention achieves the intended aim and object.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the scope of the protection of the appended claims.

1. A roller for rotating cylindrical brushes that can be applied in any industrial, road-related or other sector, of the kind constituted by a central support, having a plurality of holes, distributed with a constant spacing on an outer surface thereof for inserting and fixing respective tufts of bristles, wherein said support is constituted by at least one cylindrical ring and wherein said holes are arranged on planes that are perpendicular to an axis of the roller and are successively and alternately inclined on either side with respect to planes that are radial or parallel to radial planes that pass through the axis of the cylinder and through the respective hole in order to sweep, with the ends of the bristles, two bands arranged laterally to a row of tufts.

2. The roller according to claim 1, wherein said holes are successively and alternately inclined on either side at angles comprised between 0 and 35 degrees.

3. The roller according to claim 1, wherein the tufts of bristles are made of a material of the synthetic and/or natural and/or metallic type.

4. The roller according to claim 1, wherein said tufts of bristles in a same roller are made of different materials.

5. The roller according to claim 1, wherein said plurality of holes are distributed on said central support with a substantially constant spacing along parallel circles.

6. The roller according to claim 1, wherein said plurality of holes are distributed on said central support with a constant spacing along a cylindrical spiral.

7. The roller according to claim 1, wherein free ends of said bristles, during rotation of the support through 360 degrees, have displacements that are synchronized in two mutually perpendicular directions.
